(19) United States
(12) Patent Application Publication
(10) Pub. No.: US 2006/0130608 A1
(43) Pub. Date: Jun. 22, 2006

(54) Articulated machine guard

(75) Inventor: Johnnie L. Jones, Pierson, MI (US)

Correspondence Address: PRICE HENEVELD COOPER DEWITT & LITTON, LLP, 695 KENMOOR, S.E., P O BOX 2567, GRAND RAPIDS, MI, 49501, US

(73) Assignee: Accra-Wire Controls Inc.

(21) Appl. No.: 11/018,261

(22) Filed: Dec. 21, 2004

(51) Int. Cl. F16P 1/00

(52) U.S. Cl. 74/616

(57) ABSTRACT

A machine guard assembly for a machine comprising a support, a connection subassembly connected to the support and a guard connected to the connection subassembly, with the guard having a transparent portion. The guard can be raised and lowered relative to the support by the connection subassembly. Furthermore, the guard can be moved towards and away from the support by the connection subassembly and the guard can be rotated relative to the support. The guard can be raised to allow a person to use or attend to the machine and lowered to position the guard between the person and the machine to protect the person, with the guard allowing the person to view the machine through the transparent portion of the guard.

### BACKGROUND

The present invention relates to shields for use with machine tools and the like to deflect materials ejected from associated work areas.

In various machining operations such as grinding, buffing, polishing, drilling, milling, etc., chips, broken tools, coolant or other debris, where used, are occasionally ejected from the work areas of the machines and can present a hazard to an operator thereof or other nearby personnel and/or equipment. In an attempt to minimize and hopefully prevent injuries and damage caused by such ejected material, and for other reasons, the Occupational Health and Safety Act of 1970 was enacted, and requires in part that one or more methods of machine guarding be provided to protect the operator and other employees in the machine area from hazards such as those created by point of operation, rotating parts, or flying chips.

Customarily, protection against flying chips and the like is provided by shields extending across the forward sides of the work areas. Such shields generally mount in or in close proximity to the work areas, and when moved aside either the mount or the shield itself often impedes access to the area. Further, upon change of the workpiece setup, the mount must often be repositioned to clear the new setup. Quick change mounts such as those having magnetic bases, while intended to alleviate the aforementioned problems, scratch and tend to be bumped off the machine mounting surface, sometimes into the work area itself. Thus, present day protective shields can be inconvenient to use and adjust, which may result in improper or even lack of use of such shields.

Accordingly, an apparatus is desired having the aforementioned advantages and solving and/or making improvements on the aforementioned disadvantages. A universal machine guard that is sufficiently adjustable that it can be used with a wide variety of machines in many different installations would clearly be advantageous.

### SUMMARY OF THE PRESENT INVENTION

An aspect of the present invention is to provide a machine guard assembly for a machine comprising a support, a connection subassembly connected to the support and a guard connected to the connection subassembly, with the guard having a transparent portion. The guard can be raised and lowered relative to the support by the connection subassembly.

Furthermore, the guard can be moved towards and away from the support by the connection subassembly and the guard can be rotated relative to the support. The guard can be raised to allow a person to use or attend to the machine and lowered to position the guard between the person and the machine to protect the person, with the guard allowing the person to view the machine through the transparent portion of the guard.

Another aspect of the present invention is to provide a method of safely using a machine for processing parts comprising positioning a machine guard assembly adjacent the machine, with the machine guard assembly comprising a support, a connection subassembly connected to the support and a guard connected to the connection subassembly. The guard has a transparent portion. The guard can be raised and lowered relative to the support by the connection subassembly, the guard can be moved towards and away from the support by the connection subassembly and the guard can be rotated relative to the support. The method also includes positioning the guard between a person using or attending to the machine and the machine, processing a part, and raising the guard to allow the person to have access to the part in the machine. The method further includes removing the part from the machine and lowering the guard to position the guard between the person and the machine.

Yet another aspect of the present invention is to provide a machine guard assembly comprising a vertically adjustable support member, a horizontally adjustable support member, a lifting arm and a transparent guard. The horizontally adjustable support member is rotatably connected to the vertically adjustable support member at a first end of the horizontally adjustable support member, with the horizontally adjustable support member being rotatable about a vertical axis. The lifting arm is rotatably connected to a second end of the horizontally adjustable support member, with the lifting arm being rotatable about a horizontal axis. The transparent guard is rotatably connected to the lifting arm. The guard can be moved in three dimensions and rotated about a vertical axis.

These and other aspects, objects, and features of the present invention will be understood and appreciated by those skilled in the art upon studying the following specification, claims, and appended drawings.

### BRIEF DESCRIPTION OF DRAWINGS

FIG. 1 is a front view of a machine guard assembly of the present invention in an up position.

FIG. 2 is a front view of the machine guard assembly of the present invention in a down position with a horizontally adjustable support member rotated forward and a guard rotated clockwise.

FIG. 3A is a close-up view of a first pivot point of the machine guard assembly of the present invention.

FIG. 3B is a close-up view of a second pivot point of the machine guard assembly of the present invention.

FIG. 3C is a close-up view of a third pivot point of the machine guard assembly of the present invention.

FIG. 4 is a front view of a second embodiment of the machine guard assembly of the present invention in the down position.

FIG. 5 is a front view of an actuator for use with the second embodiment of the machine guard assembly of the present invention.

FIG. 6 is a front view of a third embodiment of the machine guard assembly of the present invention in the down position.

FIG. 7 is a partial front view of a fourth embodiment of the machine guard assembly of the present invention in the down position.

FIG. 8 is a partial front view of a fifth embodiment of the machine guard assembly of the present invention in the down position.

### DETAILED DESCRIPTION OF PREFERRED EMBODIMENTS

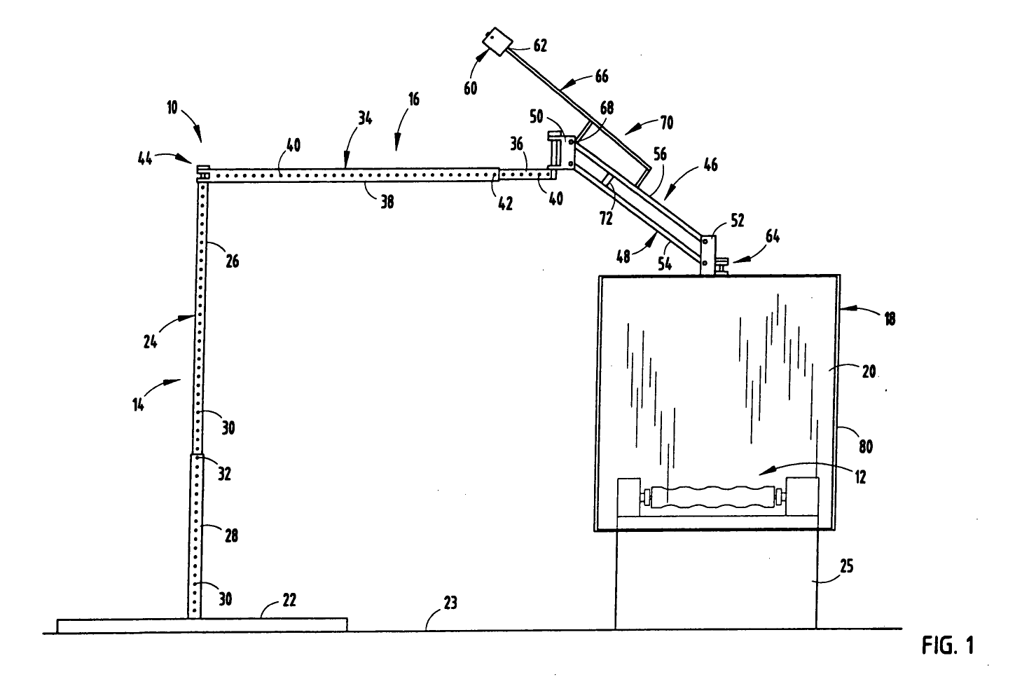

For purposes of description herein, the terms “upper,” “lower,” “right,” “left,” “rear,” “front,” “vertical,” “horizontal,” and derivatives thereof shall relate to the invention as orientated in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

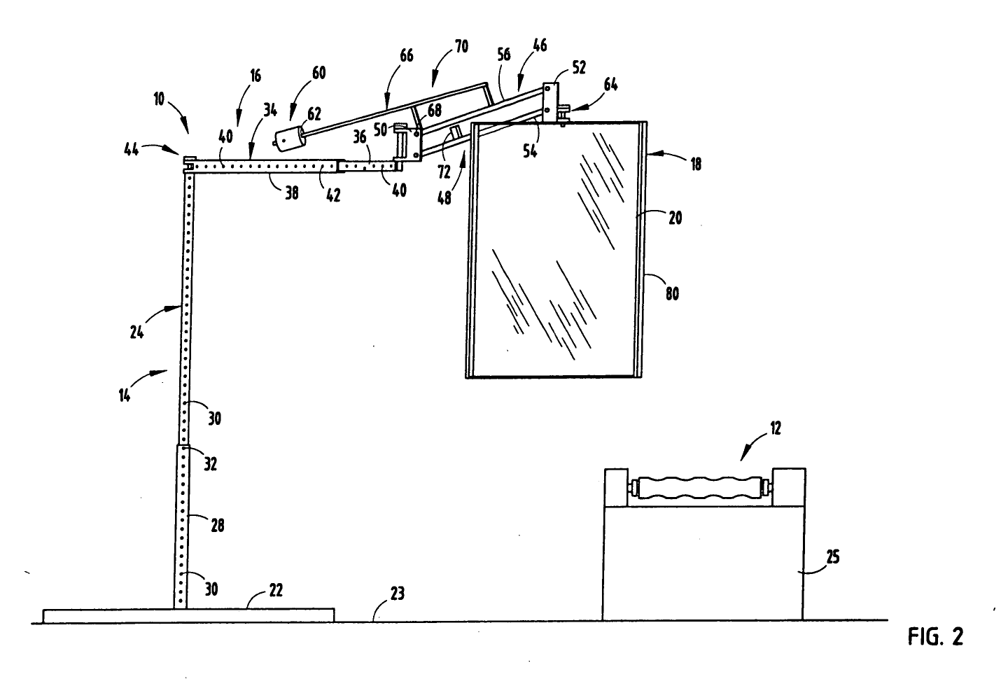

The reference number 10 (FIGS. 1-2) generally designates a machine guard assembly embodying the present invention. In the illustrated example, the machine guard assembly 10 is for use with a machine 12. The machine guard assembly 10 comprises a support 14, a connection subassembly 16 connected to the support 14 and a guard 18 connected to the connection subassembly 16, with the guard 18 having a transparent portion 20. The guard 18 can be raised and lowered relative to the support 14 by the connection subassembly 16. Furthermore, the guard 18 can be moved towards and away from the support 14 by the connection subassembly 16 and the guard 18 can be rotated relative to the support 14. The guard 18 can be raised to allow a person to use or attend to the machine 12 (FIG. 2) and lowered to position the guard 18 between the person and the machine 12 to protect the person (FIG. 1), with the guard 18 allowing the person to view the machine 12 through the transparent portion 20 of the guard 18.

In the illustrated example, the machine 12 can be any machine that could use a guard in front of a machine during use to protect the user of the machine 12. For example, the machine 12 can be a lathe, a mill, a band saw or a drill press. However, this list is not considered to be exhaustive, as any number of machines may be used.

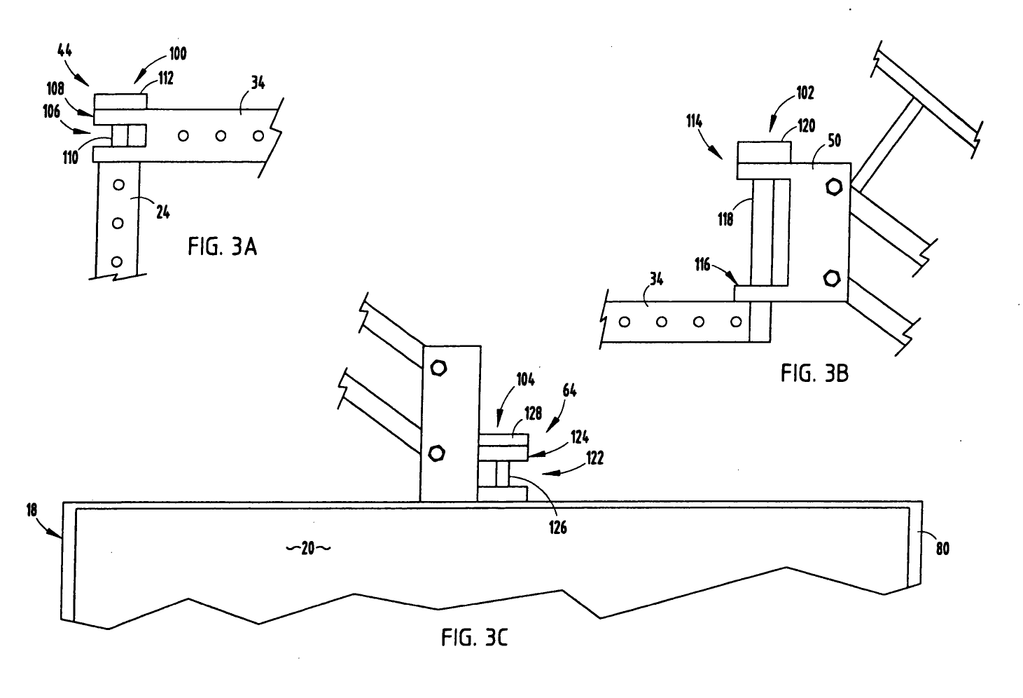

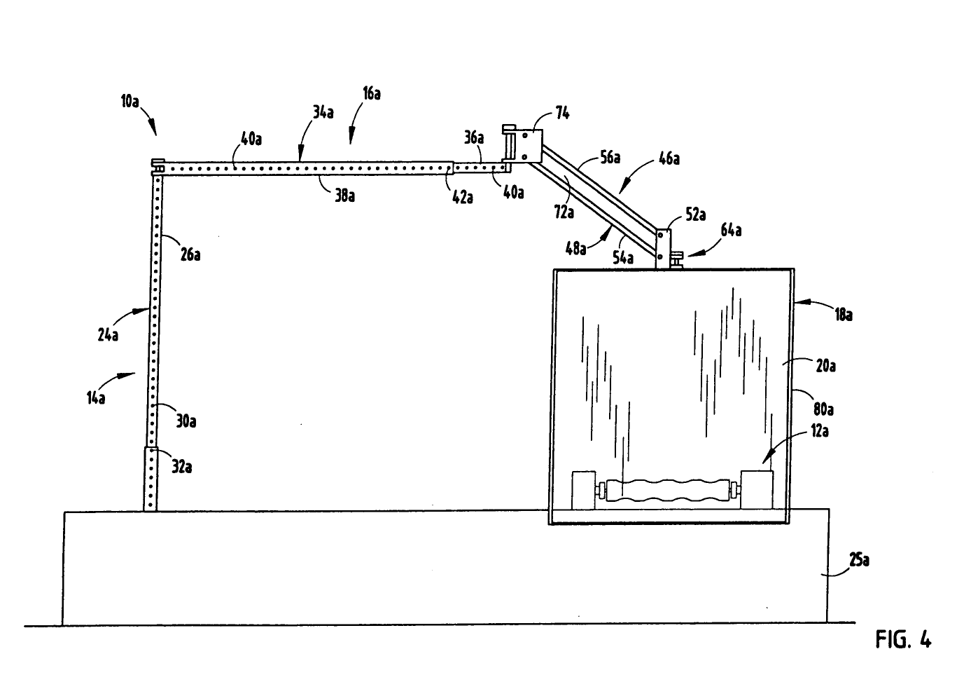

The illustrated support 14 for the machine guard assembly 10 can include a foot 22 for supporting the machine guard assembly 10 on a substantially flat surface 23. The illustrated foot 22 is not connected to the flat surface and allows a user of the machine guard assembly 10 to move the machine guard assembly 10 for use with any one of a plurality of machines in a workplace. Alternatively, the support 14 of the machine guard assembly 10 can be connected to a stand 25 for the machine 12 (FIG. 3) to thereby be connected with a particular machine 12 or to the substantially flat surface (not shown).

In the illustrated example, the support 14 for the machine guard assembly 10 includes a vertically adjustable support member 24. The vertically adjustable support member 24 includes a first telescoping tube 26 and a second telescoping tube 28. The first telescoping tube 26 is configured to slide within the second telescoping tube 28 to vertically adjust the vertically adjustable support member 24. In one embodiment, the first telescoping tube 26 and the second telescoping tube 28 include a plurality of openings 30 configured to have a pin 32 placed therethrough to lock the relative positions of the first telescoping tube 26 and the second telescoping tube 28. The pin 32 is removed from aligned openings 30 in the first telescoping tube 26 and the second telescoping tube 28 to allow the first telescoping tube 26 and the second telescoping tube 28 to be vertically adjusted. After the first telescoping tube 26 and the second telescoping tube 28 are in the desired position, the pin 32 is inserted into any pair of aligned openings 30 to lock the first telescoping tube 26 and the second telescoping tube 28 in position. In another embodiment, the first telescoping tube 26 and the second telescoping tube 28 have an internal motor for telescoping the first telescoping tube 26 and the second telescoping tube 28 to a desired position. However, it is contemplated that any means for vertically adjusting the vertically adjustable support member 24 and for locking the vertically adjustable support member 24 at a desired height can be used.

The illustrated connection subassembly 16 is rotatably connected to the support 14, thereby allowing the guard 18 to be rotated about the support 14. In the illustrated embodiment, the connection subassembly 16 includes a horizontally adjustable support member 34 rotatably connected to a top 44 of the support 14. The horizontally adjustable support member 34 is illustrated as being rotatable about a vertical axis. The horizontally adjustable support member 34 includes a first telescoping tube 36 and a second telescoping tube 38. The first telescoping tube 36 is configured to slide within the second telescoping tube 38 to vertically adjust the horizontally adjustable support member 34. In one embodiment, the first telescoping tube 36 and the second telescoping tube 38 include a plurality of openings 40 configured to have a pin 42 placed therethrough to lock the relative positions of the first telescoping tube 36 and the second telescoping tube 38. The pin 42 is removed from aligned openings 40 in the first telescoping tube 36 and the second telescoping tube 38 to allow the first telescoping tube 36 and the second telescoping tube 38 to be vertically adjusted. After the first telescoping tube 36 and the second telescoping tube 38 are in the desired position, the pin 42 is inserted into any pair of aligned openings 40 to lock the first telescoping tube 36 and the second telescoping tube 38 in position. In another embodiment, the first telescoping tube 36 and the second telescoping tube 38 have an internal motor for telescoping the first telescoping tube 36 and the second telescoping tube 38 to a desired position. However, it is contemplated that any means for horizontally adjusting the horizontally adjustable support member 34 and for locking the horizontally adjustable support member 34 at a desired length can be used.

In the illustrated example, the connection subassembly 16 further includes a lifting arm 46 connecting the guard 18 to the horizontally adjustable support member 34. The illustrated lifting arm 46 includes a four bar linkage 48 that rotates about an end of the horizontally adjustable support member 34. The four bar linkage 48 preferably includes a first vertical link 50, a second vertical link 52, a bottom link 54 and a top link 56. The four bar vertical linkage 48 preferably maintains a parallelogram shape as the lifting arm 46 is rotated about the end of the horizontally adjustable support member 34, with the first vertical link 50 and the second vertical link 52 maintaining a vertical orientation during rotation of the lifting arm 46. The lifting arm 46 preferably includes a vertical axis of rotation about the end of the horizontally adjustable support member 34 and a horizontal axis of rotation relative to the first vertical link 50.

The illustrated lifting arm 46 includes a counterweight 60 that counterweights the weight of the guard 18 to allow easy lifting and lowering of the guard 18. In the illustrated embodiment, the lifting arm 46 includes the counterweight 60 at a first end 62 thereof and the guard 18 at a second end 64 thereof. Therefore, the lifting arm 46 includes a first portion 66 on a first side of a pivot 68 of the top link about the first vertical link of the lifting arm 46 and a second portion 70 on a second side of the pivot 68 of the lifting arm 46. The counterweight 60 is on the first portion 66 and the guard 18 is on the second portion 70. The first portion 66 of the lifting arm 46 is substantially equal in weight to the second portion 70 of the lifting arm 46 and the guard 18 such that the guard 18 is easily lifted and lowered.

In the illustrated example, the lifting arm 46 includes a stop 72 extending from the bottom link 54 configured to abut against the top link 56 when the guard 18 is lowered to a predetermined position (see FIG. 1). Although the stop 72 is illustrated as extending from the bottom link 54 and abutting against the top link 56, it is contemplated that the stop 72 could extend from the top link 56 and abut against the bottom link 54 when the guard 18 is lowered to the predetermined position.

The illustrated machine guard assembly 10 includes a first pivot point 100 between the vertical support member 24 and the horizontal support member 34 (FIG. 3A), a second pivot point 102 between the horizontal support member 34 and the four-bar linkage 48 (FIG. 3B) and a third pivot point 104 between the four-bar linkage 48 and the guard 18 (FIG. 3C). The first pivot point 100 includes a first locking mechanism 106 for rotatably locking the vertical support member 24 to the horizontal support member 34. The first locking mechanism 106 includes a C-ring connector 108 extending from the horizontal support member 34. The C-ring connector 108 includes an aligned pair of openings for accepting a screw 110 extending from the vertical support member 24. A nut 112 is screwed onto the screw 110 to compress the C-ring connector 108 between the nut 112 and the top of the vertical support member 24 to rotatably lock the vertical support member 24 to the horizontal support member 34.

In the illustrated example, the second pivot point 102 includes a second locking mechanism 114 for rotatably locking the horizontal support member 34 to the four-bar linkage 48. The second locking mechanism 114 includes a C-ring connector 116 extending from the four-bar linkage 48. The C-ring connector 116 includes an aligned pair of openings for accepting a screw 118 extending upwardly from the horizontal support member 34. A nut 120 is screwed onto the screw 118 to compress the C-ring connector 116 between the nut 120 and the top of the horizontal support member 34 to rotatably lock the horizontal support member 34 to the four-bar linkage 48.

The illustrated third pivot point 104 includes a third locking mechanism 122 for rotatably locking the four-bar linkage 48 to the guard 18. The third locking mechanism 122 includes a C-ring connector 124 extending from the second vertical link 52 of the four-bar linkage 48. The C-ring connector 124 includes an aligned pair of openings for accepting a screw 126 extending upwardly from the guard 18. A nut 128 is screwed onto the screw 126 to compress the C-ring connector 124 between the nut 128 and the top of the guard 18 to rotatably lock the four-bar linkage 48 to the guard 18. The nuts 112, 120 and 128 could comprise wing-nuts for easily locking the first locking mechanism 106, the second locking mechanism 114 and the third locking mechanism 122. Although a particular first locking mechanism 106, second locking mechanism 114 and third locking mechanism 122 are illustrated, it is contemplated that any means could be employed to rotatably lock the vertical support member 24 to the horizontal support member 34, rotatably lock the horizontal support member 34 to the four-bar linkage 48 and rotatably lock the four-bar linkage 48 to the guard 18.

The illustrated guard 18 is rotatably connected to the lifting arm 46 of the connection subassembly 16 and is rotatable about a vertical axis. The guard 18 preferably includes the transparent portion 20 to allow a user of the machine guard assembly 10 to view the machine 12. The guard 18 preferably includes a plastic frame 80, with the transparent portion 20 comprising glass, a sheet of solid transparent resinous material sold under the trademark PLEXIGLASS®, or other similar materials. The guard 18 preferably includes a plurality of film layers placed over the transparent portion 20 that allow a user of the machine guard assembly 10 to remove one layer of film when the top layer of film becomes too dirty to thereby easily allow the user of the machine guard assembly 10 to once again clearly see through the transparent portion 20.

The reference numeral 10a (FIG. 4) generally designates another embodiment of the present invention, having a second embodiment for the machine guard assembly. Since machine guard assembly 10a is similar to the previously described machine guard assembly 10, similar parts appearing in FIGS. 1-3 and FIG. 4, respectively, are represented by the same, corresponding reference number, except for the suffix “a” in the numerals of the latter. As illustrated in FIG. 4, the lifting arm 46a of the second embodiment of the machine guard assembly includes an actuator 74 that rotates the lifting arm 46a about the end of the horizontally adjustable support member 34a. It is contemplated that the lifting arm 46a could include both the actuator 74 and a counterweight to allow a low power motor to be used. However, a counterweight is not needed when the actuator 74 is used.

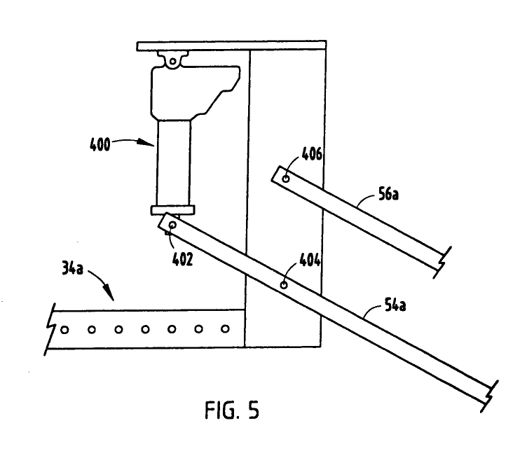

FIG. 5 illustrates an actuator 74 for use with the second embodiment of the machine guard assembly. The actuator 74 illustrated in FIG. 5 includes a linear ram 400 configured to selectively push against an end 402 of the bottom link 54a of the four-bar linkage 48a to thereby rotate the four-bar linkage 48a. The linear ram 400 can be hydraulically driven or pneumatically driven. The linear ram 400 could also comprise an electric ball screw. It is contemplated that the linear ram 400 can comprise any linearly expanding mechanism that would force the end 402 of the bottom link 54a about a top pivot point 404 of the bottom link 54a. It is also contemplated that the liner ram 400 could be engaged with the top link 56a of the four-bar linkage 48a to rotate the four-bar linkage 48a about a top pivot point 406 of the top link 56a.

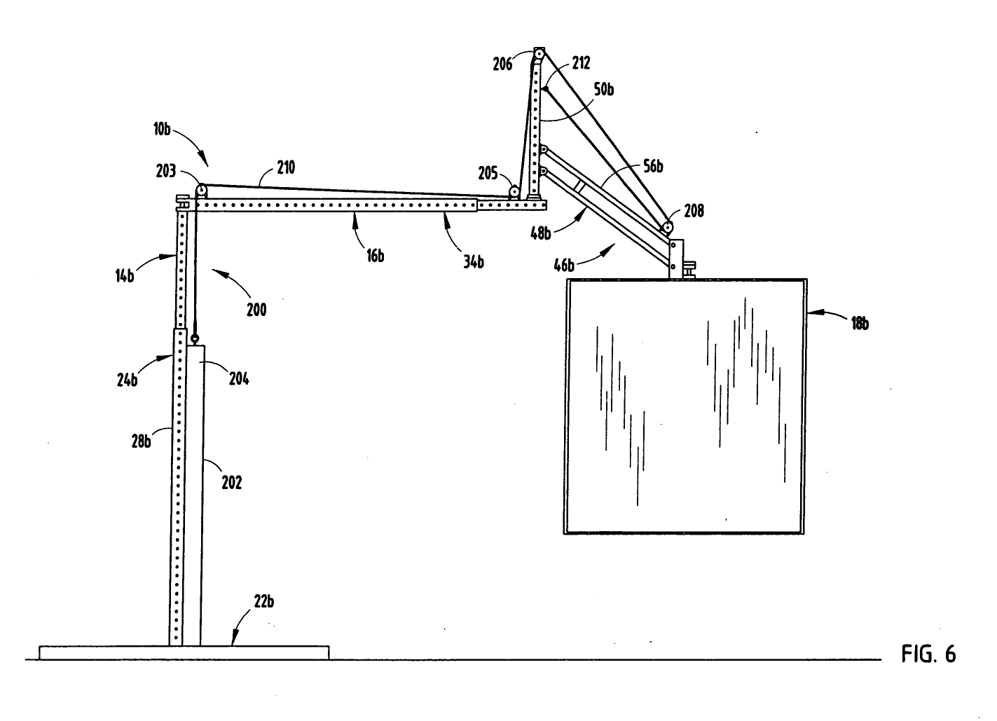

The reference numeral 10b (FIG. 6) generally designates another embodiment of the present invention, having a third embodiment for the machine guard assembly. Since machine guard assembly 10b is similar to the previously described machine guard assembly 10, similar parts appearing in FIGS. 1-3 and FIG. 6, respectively, are represented by the same, corresponding reference number, except for the suffix “b” in the numerals of the latter. As illustrated in FIG. 6, the lifting arm 46b of the third embodiment of the machine guard assembly 10b includes a counterweight and pulley system 200 for easily lifting and lowering the lifting arm 46b and the guard 18b. The counterforce and pulley system 200 includes a weight housing tube 202 connected to the second telescoping tube 28b of the vertical support member 24b, a weight 204 slidable within the weight housing tube 202, a first pulley 203 and a second pulley 205 connected to the horizontal support member 34b, an extended first vertical link 50b of the lifting arm 46b having a third pulley 206 at an upper end thereof, a fourth pulley 208 at an end of the top link 56b of the four bar linkage 48b, and a cable 210 extending between a top of the weight 204 and a pin 212 adjacent the upper end of the extended first vertical link 50b. The cable 210 extends upwardly from the weight 204, around a top of the first pulley 203, around a bottom of the second pulley 205, over a top of the third pulley 206, around the fourth pulley 208 and is connected to the pin 212.

During use, as the lifting arm 46b is raised, a total distance of the cable 210 from the pin 212 to the fourth pulley 208 and back to the third pulley 206 decreases, thereby forcing the weight 204 downward in the weight housing tube 202. Likewise, as the lifting arm is lowered, the total distance of the cable 210 from the pin 212 to the fourth pulley 208 and back to the third pulley 206 increases, thereby forcing the weight 204 downward in the weight housing tube 202. The weight 204 acts as a counterweight to the guard 18b and the lifting arm 46a to easily allow the lifting arm 46a and the guard 18b to be easily raised and lowered.

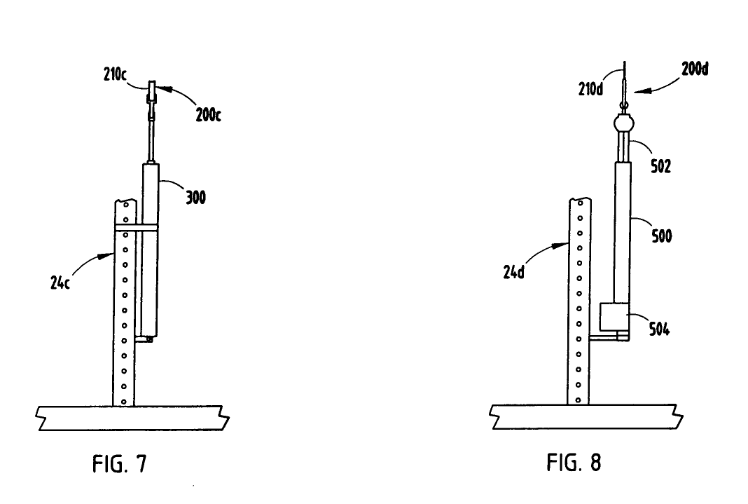

The reference numeral 10c (FIG. 7) generally designates another embodiment of the present invention, having a fourth embodiment for the machine guard assembly. Since machine guard assembly 10c is similar to the previously described machine guard assembly 10b, similar parts appearing in FIG. 6 and FIG. 7, respectively, are represented by the same, corresponding reference number, except for the suffix “c” in the numerals of the latter. As illustrated in FIG. 7, the fourth embodiment of the machine guard assembly 10c is identical to the third embodiment of the machine guard assembly 10b, except that the weight 204 and the weight housing tube 202 of the counterforce and pulley system 200c is replaced with a dampener or free gas spring 300 that slows the cable 210c at the connection point to the dampener or free gas spring from elevating relative to the dampener or free gas spring 300, thereby slowing the lowering of the guard 18c. It is contemplated that the dampener or free gas spring 300 can compress gas or other fluid therein to slow the elevating of the cable 210c at the connection point to the dampener or free gas spring 300. However, the dampener 300 could use other methods to slow the elevation of the cable 210c.

The reference numeral 10d (FIG. 8) generally designates another embodiment of the present invention, having a fifth embodiment for the machine guard assembly. Since machine guard assembly 10d is similar to the previously described machine guard assembly 10b, similar parts appearing in FIG. 6 and FIG. 8, respectively, are represented by the same, corresponding reference number, except for the suffix “d” in the numerals of the latter. As illustrated in FIG. 8, the fifth embodiment of the machine guard assembly 10d is identical to the third embodiment of the machine guard assembly 10b, except that the weight 204 and the weight housing tube 202 of the counterforce and pulley system 200d is replaced with a motor assisted telescoping tube assembly 500. The motor assisted telescoping tube assembly 500 includes a telescoping tube 502 connected to the cable 210d at a connection point to the motor assisted telescoping tube assembly 500. The motor assisted telescoping tube assembly 500 includes a motor 504 for raising and lowering the telescoping tube 502, to thereby assist in raising and lowering the cable 210d at the connection point to telescoping tube 502 and thereby assisting in lowering and raising the guard 18d, respectively.

It is to be understood that variations and modifications can be made on the aforementioned structure without departing from the concepts of the present invention. For example, it is contemplated that the lifting arm 46 could be raised and lowered to position by any means. The lifting arm 46 could comprise a ratchet that will maintain the lifting arm 46 in a selected position that would reset when the lifting arm 46 is fully lifted to allow the guard to be lowered to a lowermost position. Moreover, it is understood that the actuator 74 could be used with the machine guard assembly on a support surface, connected to the support surface or connected to a stand for a machine. Furthermore, it is to be understood that such concepts are intended to be covered by the following claims unless these claims by their language expressly state otherwise.

We claim:

1. A machine guard assembly for a machine comprising:
a support;
a connection subassembly connected to the support; and
a guard connected to the connection subassembly, the guard having a transparent portion;
wherein the guard can be raised and lowered relative to the support by the connection subassembly, the guard can be moved towards and away from the support by the connection subassembly and the guard can be rotated relative to the support; and
wherein the guard can be raised to allow a person to use or attend to the machine and lowered to position the guard between the person and the machine to protect the person, the guard allowing the person to view the machine through the transparent portion of the guard.

2. The machine guard assembly of claim 1, wherein:
the support comprises a vertically adjustable support member.

3. The machine guard assembly of claim 1, wherein:
the connection subassembly has a pulley system connected thereto, the pulley system including a counterforce mechanism for easily lowering the guard.

4. The machine guard assembly of claim 4, wherein:
the connection subassembly is rotatably connected to the support.

5. The machine guard assembly of claim 4, wherein:
the connection subassembly and the support include a locking mechanism for locking the connection subassembly to the support in a selected rotatable position.

6. The machine guard assembly of claim 4, wherein:
the connecting subassembly comprises a horizontally adjustable support member rotatably connected to the support and a lifting arm rotatably connected to the horizontally adjustable support member.

7. The machine guard assembly of claim 6, wherein:
the connecting subassemly includes an actuator for rotating the lifting arm.

8. The machine guard assembly of claim 6, wherein:
the support comprises a vertically adjustable support member.

9. The machine guard assembly of claim 8, wherein:
the vertically adjustable support member and the horizontally adjustable support member include a locking mechanism for locking the horizontally adjustable support member to the vertically adjustable support member in a selected rotatable position.

10. The machine guard assembly of claim 6, wherein:
the connection subassembly includes a locking mechanism for locking the horizontally adjustable support member to the lifting arm in a selected rotatable position.

11. The machine guard assembly of claim 6, wherein:
the lifting arm includes a counterweight at a first end thereof and the guard at a second end thereof;
the lifting arm includes a first portion on a first side of a pivot of the lifting arm and a second portion on a second side of the pivot of the lifting arm;
the counterweight is on the first portion and the guard is on the second portion; and
the first portion is substantially equal in weight to the second portion and the guard such that the guard is easily lifted and lowered.

12. The machine guard assembly of claim 6, wherein:
the lifting arm includes a stop for stopping rotation of the lifting arm about the horizontally adjustable support member.

13. The machine guard assembly of claim 6, wherein:
the guard is rotatably connected to the lifting arm, with the guard being rotatable about a vertical axis relative to the lifting arm.

14. The machine guard assembly of claim 1, wherein:
the connection subassembly comprises a horizontally adjustable support member and a lifting arm; and
an actuator rotates the lifting arm about the horizontally adjustable support member to raise and lower the guard.

15. The machine guard assembly of claim 14, wherein:
the connection subassembly includes a locking mechanism for locking the horizontally adjustable support member to the lifting arm in a selected rotatable position.

16. The machine guard assembly of claim 1, wherein:
the connection subassembly and the guard include a locking mechanism for locking the connection subassembly to the guard in a selected rotatable position.

17. The machine guard assembly of claim 1, wherein:
the guard includes a plurality of removable transparent films located over the transparent portion.

18. A method of safely using a machine for processing parts comprising:
positioning a machine guard assembly adjacent the machine, the machine guard assembly comprising a support, a connection subassembly connected to the support and a guard connected to the connection subassembly, with the guard having a transparent portion, wherein the guard can be raised and lowered relative to the support by the connection subassembly, the guard can be moved towards and away from the support by the connection subassembly and the guard can be rotated relative to the support;
positioning the guard between a person using or attending to the machine and the machine;
processing a part;
raising the guard to allow the person to have access to the part in the machine;
removing the part from the machine; and
lowering the guard to position the guard between the person and the machine.

19. The method of safely using a machine for processing parts of claim 18, wherein:
the support comprises a vertically adjustable support member.

20. The method of safely using a machine for processing parts of claim 18, wherein:
the connection subassembly has a pulley system connected thereto, the pulley system including a counterforce mechanism for easily lowering the guard.

21. The method of safely using a machine for processing parts of claim 18, further including:
rotatably connecting the connection subassembly to the support.

22. The method of safely using a machine for processing parts of claim 21, further including:
locking the connection subassembly to the support in a selected rotatable position.

23. The method of safely using a machine for processing parts of claim 21, wherein:
the connecting subassembly comprises a horizontally adjustable support member rotatably connected to the support and a lifting arm rotatably connected to the horizontally adjustable support member.

24. The method of safely using a machine for processing parts of claim 23, wherein:
raising the guard and lowering the guard comprise rotating the lifting arm with an actuator.

25. The method of safely using a machine for processing parts of claim 23, wherein:
the support comprises a vertically adjustable support member.

26. The method of safely using a machine for processing parts of claim 25, further including:
locking the horizontally adjustable support member to the vertically adjustable support member in a selected rotatable position.

27. The method of safely using a machine for processing parts of claim 23, further including:
locking the horizontally adjustable support member to the lifting arm in a selected rotatable position.

28. The method of safely using a machine for processing parts of claim 23, wherein:
the lifting arm includes a counterweight at a first end thereof and the guard at a second end thereof;
the lifting arm includes a first portion on a first side of a pivot of the lifting arm and a second portion on a second side of the pivot of the lifting arm;
the counterweight is on the first portion and the guard is on the second portion; and
the first portion is substantially equal in weight to the second portion and the guard such that the guard is easily lifted and lowered.

29. The method of safely using a machine for processing parts of claim 23, further including:
stopping rotation of the lifting arm about the horizontally adjustable support member with a stop.

30. The method of safely using a machine for processing parts of claim 23, further including:
rotatably connecting the guard to the lifting arm, with the guard being rotatable about a vertical axis relative to the lifting arm.

31. The method of safely using a machine for processing parts of claim 18, wherein:
the support comprises a vertically adjustable support member and a lifting arm; and
raising the guard and lowering the guard comprise rotating the lifting arm with an actuator.

32. The method of safely using a machine for processing parts of claim 31, further including:
locking the horizontally adjustable support member to the lifting arm in a selected rotatable position.

33. The method of safely using a machine for processing parts of claim 18, further including:
locking the connection subassembly to the guard in a selected rotatable position.

34. The method of safely using a machine for processing parts of claim 18, wherein:
the guard includes a plurality of removable films located over the transparent portion.

35. A machine guard assembly comprising:
a vertically adjustable support member;
a horizontally adjustable support member rotatably connected to the vertically adjustable support member at a first end of the horizontally adjustable support member, the horizontally adjustable support member being rotatable about a vertical axis;
a lifting arm rotatably connected to a second end of the horizontally adjustable support member, the lifting arm being rotatable about a horizontal axis;
a transparent guard rotatably connected to the lifting arm;
wherein the guard can be moved in three dimensions and rotated about a vertical axis.

36. The machine guard assembly of claim 35, wherein:
the lifting arm has a pulley system connected thereto, the pulley system including a counterforce mechanism for easily lowering the guard.

37. The machine guard assembly of claim 35, wherein:
the lifting arm includes a counterweight at a first end thereof and the guard at a second end thereof;
the lifting arm includes a first portion on a first side of a pivot of the lifting arm and a second portion on a second side of the pivot of the lifting arm;
the counterweight is on the first portion and the guard is on the second portion; and
the first portion is substantially equal in weight to the second portion and the guard such that the guard is easily lifted and lowered.

38. The machine guard assembly of claim 35, wherein:
an actuator rotates the lifting arm about the horizontally adjustable support member to raise and lower the guard.

39. The machine guard assembly of claim 35, wherein:
the vertically adjustable support member and the horizontally adjustable support member include a locking mechanism for locking the horizontally adjustable support member to the vertically adjustable support member in a selected rotatable position.

40. The machine guard assembly of claim 35, wherein:
the lifting arm and the horizontally adjustable support member include a locking mechanism for locking the horizontally adjustable support member to the lifting arm in a selected rotatable position.

41. The machine guard assembly of claim 35, wherein:
the lifting arm includes a stop for stopping rotation of the lifting arm about the horizontally adjustable support member.

42. The machine guard assembly of claim 35, wherein:
the guard is rotatable about a vertical axis relative to the lifting arm.

43. The machine guard assembly of claim 35, wherein:
the lifting arm and the guard include a locking mechanism for locking the guard to the lifting arm in a selected rotatable position.

44. The machine guard assembly of claim 35, wherein:
the guard includes a plurality of removable transparent films located over the transparent portion.
